(19) United States
(12) Patent Application Publication
(10) Pub. No.: US 2023/0275794 A1
(43) Pub. Date: Aug. 31, 2023

(54) METHODS FOR COMMUNICATIONS, TERMINAL DEVICE, NETWORK DEVICE AND COMPUTER READABLE MEDIA

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 18/016,111

(22) PCT Filed: Jul. 17, 2020
(86) PCT No.: PCT/CN2020/102796

§ 371 Date: Jan. 13, 2023

(51) Int. Cl. H04L 27/26; H04L 5/00

(52) U.S. Cl. CPC H04L 27/2614; H04L 5/0053; H04L 5/0007

(57) ABSTRACT

Embodiments of the present disclosure provide a solution for transmission of UCI. A method for communications comprises generating, at a terminal device, a value corresponding to information bits in UCI. The method also comprises generating a sequence indicating the UCI based on the value. The method also comprises transmitting the sequence to a network device.

### FIELD

Embodiments of the present disclosure generally relate to the field of communication, and in particular, to a solution for transmission of uplink control information (UCI) based on a sequence.

### BACKGROUND

In order to support transmission of downlink and uplink transport channels, a terminal device needs to transmit UCI to a network device. The transmission of the UCI may be payload-based. The payload-based transmission refers to transmitting signals carrying information bits (also referred to as payload). In the payload-based transmission of UCI, information bits in the UCI will be encoded using channel coding and modulation. Then, the encoded information bits are multiplexed with Demodulation Reference Signals (DMRS) either in a Time Division Multiplexing (TDM) manner or a Frequency Division Multiplexing (FDM) before transmission. At the side of the network device, the network device will first perform a channel estimation using the DMRS, and then coherently combine the encoded information bits using the estimated channel. Thus, the payload-based transmission is also referred to as DMRS based coherent transmission. However, the channel estimation, demodulation and decoding will cause a high latency of the transmission of UCI.

### SUMMARY

In general, example embodiments of the present disclosure provide a solution for transmission of UCI based on a sequence.

In a first aspect, there is provided a method for communications. The method comprises generating, at a terminal device, a value corresponding to information bits in UCI. The method also comprises generating a sequence indicating the UCI based on the value. The method also comprises transmitting the sequence to a network device.

In a second aspect, there is provided a method for communications. The method comprises receiving, at a network device from a terminal device, a sequence indicating UCI. The method also comprises determining the sequence by determining correlation between the sequence and a plurality of candidate sequences. The method also comprises determining the UCI based on the determined sequence.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a network device. The network device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 illustrates an example signaling chart showing an example process for transmission of UCI based on a sequence in accordance with some embodiments of the present disclosure;

FIG. 3 illustrates a flowchart of an example method in accordance with some embodiments of the present disclosure;

FIG. 4 illustrates a flowchart of another example method in accordance with some embodiments of the present disclosure; and

FIG. 5 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X communication, a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, some embodiments will be described with reference to UEs as examples of terminal devices and the terms “terminal device” and “user equipment” (UE) may be used interchangeably in the context of the present disclosure.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As described above, in the payload-based transmission, the channel estimation, demodulation and decoding will cause a high latency of the transmission of UCI.

In order to solve the above technical problems in conventional solutions, embodiments of the present disclosure provide a solution for transmission of UCI based on a sequence. In this solution, a terminal device generates a sequence indicating UCI and transmits the sequence to a network device. In other words, the UCI is represented by the sequence instead of payload of the UCI. In this way, no DMRS needs to be multiplexed with the encoded information bits in the UCI for transmission. Thus, at the side of the network device, the network device does not need to perform a channel estimation using the DMRS, or decode using the estimated channel. In this regard, the solution for transmission of UCI according to the present disclosure is referred to as DMRS-less non-coherent transmission or sequence based transmission. With this solution, the latency of the transmission of UCI may be reduced.

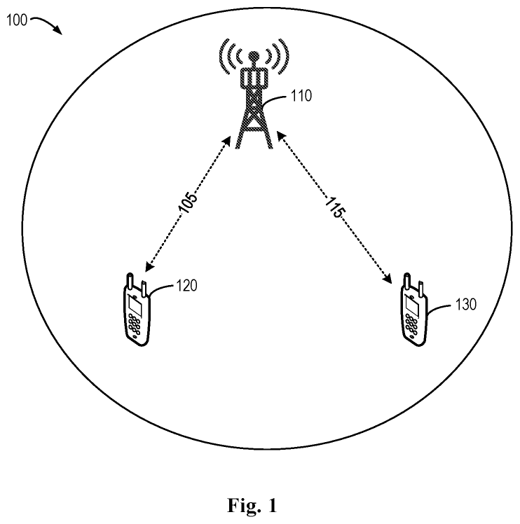

FIG. 1 is a schematic diagram of a communication environment 100 in which some embodiments of the present disclosure can be implemented. As shown in FIG. 1, the communication environment 100, which may also be referred to as a communication network 100, includes a network device 110 serving a first terminal device 120 and a second terminal device 130. In particular, the first terminal device 120 may communicate with the network device 110 via a communication channel 105, and the second terminal device 130 may communicate with the network device 110 via a communication channel 115.

For transmissions from the network device 110 to the first terminal device 120 or the second terminal device 130, the communication channel 105 or 115 may be referred to as a downlink channel. For transmissions from the first terminal device 120 or the second terminal device 130 to the network device 110, the communication channel 105 or 115 may be referred to as an uplink channel. In the following, the first terminal device 120 and the second terminal device 130 can also be referred to as the terminal device 120 and the terminal device 130 for simplicity.

Although the network device 110, the first terminal device 120 and the second terminal device 130 are described in the communication environment 100 of FIG. 1, embodiments of the present disclosure may be equally applicable to any other suitable communication devices in communication with one another. That is, embodiments of the present disclosure are not limited to the example scenario of FIG. 1. In this regard, it is noted that although the first and second terminal devices 120 and 130 are schematically depicted as mobile phones in FIG. 1, it is understood that this depiction is only for example without suggesting any limitation. In other embodiments, the first and second terminal devices 120 and 130 may be any other wireless communication devices, for example, vehicle-mounted terminal devices.

It is to be understood that the number of the terminal devices and the number of the network devices as shown in FIG. 1 are only for the purpose of illustration without suggesting any limitations. The communication environment 100 may include any suitable number of terminal devices, any suitable number of network devices, and any suitable number of other communication devices adapted for implementing embodiments of the present disclosure. In addition, it would be appreciated that there may be various wireless communications as well as wireline communications (if needed) among all the communication devices.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

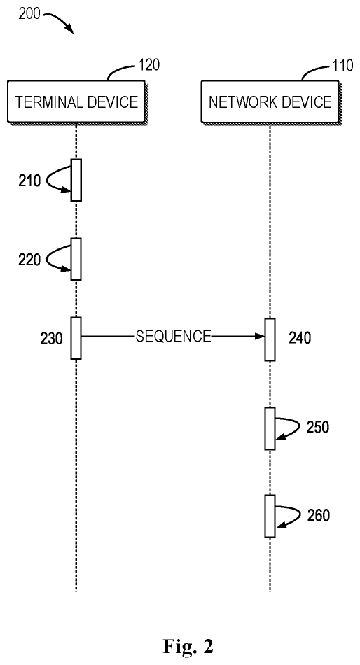

FIG. 2 illustrates an example signaling chart showing an example process 200 for transmission of UCI based on a sequence in accordance with some embodiments of the present disclosure. For the purpose of discussion, the communication process 200 will be described with reference to FIG. 1. However, it would be appreciated that the communication process 200 may be equally applicable to other communication scenarios where a network device and a terminal device communicate with each other.

As shown in FIG. 2, the terminal device 120 generates (210) a value corresponding to information bits in UCI. In some embodiments, the value is a binary value. In other embodiments, the value may be any appropriate value.

The terminal device 120 generates (220) a sequence indicating the UCI based on the value. In some embodiments, the network device 110 may transmit to the terminal device 120 a signaling indicating a type of the sequence. Upon receiving the signaling, the terminal device 120 generates the sequence based on the signaling. In other embodiments, the type of the sequence may be predefined. Thus, the terminal device 120 may generate the sequence without receiving the signaling.

The terminal device 120 transmits (230) the sequence to the network device 110. In some embodiments, the network device 110 may transmit to the terminal device 120 a signaling indicating that the sequence is to be transmitted. The terminal device 120 transmits the sequence based on the signaling.

In some embodiments, the signaling may further indicate a format of a control channel on which the sequence is to be transmitted. Example of the control channel may include, but is not limited to Physical Uplink Control Channel (PUCCH).

Accordingly, the network device 110 receives (240) the sequence from the terminal device 120.

Upon receiving the sequence, the network device 110 determines (250) the sequence by determining correlation between the sequence and a plurality of candidate sequences. In some embodiments, if the network device 110 determines correlation between the sequence and a first candidate sequence among the plurality of candidate sequences is higher than correlation between the sequence and other candidate sequences among the plurality of candidate sequences, the network device 110 determines the first candidate sequence as the sequence. In turn, the network device 110 determines (260) the UCI based on the determined sequence.

In some embodiments, the number of the information bits may be above 2.

In some embodiments, the terminal device 120 may update the information bits by appending at least one padding bit to the information bits based on the number of the information bits and the maximum information bits in sequence based transmission. Hereinafter, the maximum information bits in sequence based transmission is represented by K. K may be predefined or configured as any appropriate value by the network device 110. For example, K may be in the range of 7 to 11.

Consider an example where K=4, and the network device 110 transmits four packets on Physical Downlink Shared Channel (PDSCH). The terminal device 120 may correctly decode three packets and the DCI associated with the last packet is missing. Thus, the terminal device 120 may generate feedback information as 111. In other words, in this example, the UCI is 111. If the terminal device 120 transmits a sequence indicating the UCI of 111 to the network device 110, the network device 110 may misunderstand the actual UCI should be 0111. Thus, the network device 110 will not know the missing of the last DCI.

In order to solve the above problem, in accordance with some embodiments, because the number (i.e., 3) of the information bits is below K (i.e., 4), the terminal device 120 may append one padding bit to the information bits. For example, the terminal device 120 may append one padding bit “0” to the information bits 111 so as to obtain updated information bits 1110. Then, the terminal device 120 generates the value as 1110B based on the updated information bits 1110, where B represents 1110 is a binary number. In this way, it makes sure that misdetection of the last DCI will not cause a transmission of a wrong sequence, and thus will not cause misunderstanding of the network device 110.

In some embodiments, the sequence comprises a pseudo-random sequence. In some embodiments, the pseudo-random sequence comprises a Gold sequence having a length of 31.

In some embodiments, the terminal device 120 determines a parameter for initializing a generator for the pseudo-random sequence based on the value. In turn, the terminal device 120 generates the sequence based on the parameter.

In some embodiments, the terminal device 120 may update the value based on 2^{d}s, where s represents the value and d represents a position of s in a length of the pseudo-random sequence. The terminal device 120 may determine the parameter based on the updated value. For example, the terminal device 120 may determine the parameter based on the following:

cᵢₙᵢₜ=(2^{d}s+2¹⁷(N_{symb}^{slot}n_{s,f}^{μ}+l+1)(2N_{ID}⁰+1)+2N_{ID}⁰)mod 2³¹ (1)

s=Σᵢ₌₀^{K-1}aᵢ·2^{K-1-i}or s=Σᵢ₌₀^{K-1}aᵢ·2ⁱ

where cᵢₙᵢₜ represents the parameter for initializing a generator for the pseudo-random sequence, s represents the value, d represents the position of s in the length of the pseudo-random sequence, N_{symb}^{slot} represents the number of OFDM symbols in one slot, l represents the OFDM symbol index within the slot, n_{s,f}^{μ} represents the slot index within the radio frame, and the quantity N_{ID}⁰∈{0,1, . . . ,65535} is given by the higher-layer parameter scramblingID0 in the DMRS-UplinkConfig IE if provided and by N_{ID}^{cell} otherwise, N_{ID}^{cell} represents an identity of a cell, aᵢ represents the (i+1)-th bits in UCI.

In some embodiments, d may be preconfigured as any appropriate value, for example 20. In other embodiments, d may be equal to 31−K.

In some embodiments, in order to support multiplexing of sequences generated by multiple terminal devices on a single RB, for example, the terminal devices 120 and 130, the network device 110 may configure an offset of the position of the value for each of the multiple terminal devices. Thus, bits in values generated by the multiple terminal devices may be moved left different numbers of bits. In such embodiments, for example, the terminal device 120 may determine the parameter based on the following:

cᵢₙᵢₜ=(2^{d+L}s+2¹⁷(N_{symb}^{slot}n_{s,f}^{μ}+l+1)(2N_{ID}⁰+1)+2N_{ID}⁰)mod 2³¹ (2)

where L represents the offset of the position of the value s configured for the terminal device 120.

It is to be understood that the above equations (1) and (2) are described by way of example without suggesting any limitation on the scope of the present disclosure. The parameter for initializing the generator for the Gold sequence may be determined in any appropriate manner.

Upon determining the parameter for initializing the generator for the Gold sequence, the Gold sequence may be generated based on the parameter.

In some embodiments, the pseudo-random sequence c(n) of length M_{PN}, where n=0,1, . . . , M_{PN}−1, may be generated by the following:

c(n)=(x₁(n+N_{C})+x₂(n+N_{C}))mod 2

x₁(n+31)=(x₁(n+3)+x₁(n))mod 2 (3)

x₂(n+31)=(x₂(n+3)+x₂(n+2)+x₂+(n+1)+x₂(n))mod 2

where N_{C}=1600 and the first m-sequence x₁(n) shall be initialized with x₁(0)=1, x₁(n)=0, n=1,2, . . . , 30. The initialization of the second m-sequence, x₂(n), is denoted by cᵢₙᵢₜ=Σᵢ₌₀³⁰x₂(i)·2ⁱ with the value depending on the application of the sequence. In this example, the length M_{PN} is equal to 31.

In some embodiments, the pseudo-random sequence may be a short sequence per OFDM symbol.

In other embodiments, the pseudo-random sequence may be a long sequence. In such embodiments, the pseudo-random sequence may be first mapped to resource elements in frequency domain and then mapped to resource elements in time domain

In some embodiments, the sequence comprises an extended Low-PAPR sequence.

In some embodiments, the extended Low-PAPR sequence may be mapped to a single resource block (RB) without frequency hopping. The terminal device 120 may generate the extended Low-PAPR sequence by using two-dimension orthogonal sequences. In this case, the terminal device 120 may generate a first set of orthogonal sequences in frequency domain based on the value s. The terminal device 120 may also generate a second set of orthogonal sequences in time domain based on the value s. Then, the terminal device 120 may generate the extended Low-PAPR sequence by multiplying the first and second sets of orthogonal sequences by a Low-PAPR base sequence.

In the embodiments where the extended Low-PAPR sequence may be mapped to a single resource block (RB), the extended Low-PAPR sequence may be mapped to 168 resource elements in the single RB. That is, the extended Low-PAPR sequence may be mapped to 12 subcarriers in frequency domain and 14 symbols in time domain. In such embodiments, the number of the orthogonal sequences in the first set is 12, and the number of the orthogonal sequences in the second set is 14. In this case, the extended Low-PAPR sequence rₛ(n,m) (also referred to as the modulation symbol rₛ(n,m) of corresponding to the UCI) may be generated as below:

$${f}_{p} ( n ) = {e}^{\frac{j 2 π pn}{12}} \qquad ( 4 )$$

$${t}_{q} ( m ) = {e}^{\frac{j 2 π qm}{14}}$$

$${r}_{s} ( n , m ) = {f}_{p} ( n ) \cdot {t}_{1} ( m ) \cdot {\overline{r}}_{u , v} ( n )$$

Where fₚ(n) represents a sequence in the first set of orthogonal sequences, p represents an index of a sequence in the first set and is equal to 0, . . . , 11, n represents an index of a subcarrier in frequency domain and is equal to 0, . . . , 11; t_{q}(m) represents a sequence in the second set of orthogonal sequences, q represents an index of a sequence in the second set and is equal to 0, . . . , 13, m represents an index of an OFDM symbol in time domain and is equal to 0, . . . , 13; and r̅_{u,v}(n) represents a Low-PAPR base sequence. Base sequences r̅_{u,v}(n) are divided into groups, where u∈{0, 1, . . . , 29} represents the group number and v represents the base sequence number within the group

In the above example, s=14*p′+q, p′=p or p′=table (p) based on Table 1 below. In other words, q=s mod 14, p′=[s/14].

TABLE 1

| | | | | | | | | | | | | |
|---|---|---|---|---|---|---|---|---|---|---|---|---|
| p' | 0 | 1 | 2 | 3 | 4 | 5 | 6 | 7 | 8 | 9 | 10 | 11 |
| p | 0 | 3 | 6 | 9 | 1 | 4 | 7 | 10 | 2 | 5 | 8 | 11 |

As can be seen from Table 1, p is determined such that if two values of p′ are adjacent to each other, corresponding values of p are not adjacent to each other. In this way, multiplexing of sequences generated by multiple terminal devices may be achieved.

In some embodiments, the number of the orthogonal sequences in the first set and the number of the orthogonal sequences in the second set may be determined based on resources to which the extended Low-PAPR sequence may be mapped to. In this regard, the number “12” in the expression fₚ(n) may be replaced with Nf and the number “14” in the expression t_{q}(m) may be replaced with Nt. In the above equation (4), it is assumed that the extended Low-PAPR sequence may be mapped to 12 subcarriers in frequency domain and 14 symbols in time domain. Thus, the number Nf of the orthogonal sequences in the first set is 12 and the number Nt of the orthogonal sequences in the second set is 14. This is described by way of example without suggesting any limitation on the scope of the present disclosure.

In the embodiments where the extended Low-PAPR sequence may be mapped to a single resource block (RB) without frequency hopping, the terminal device 120 may generate the extended Low-PAPR sequence by using one-dimension orthogonal sequences. In this case, the terminal device 120 may select a second predetermined number of elements from a Discrete Fourier Transformation (DFT) matrix based on the value s and generate the extended Low-PAPR sequence by multiplying the selected elements by the Low-PAPR base sequence. In this way, at the side of the network device 110, Fast Fourier Transformation (FFT) may be used to detect the value s.

In some embodiments, if the number of the information bits is below K, the terminal device 120 may determine an orthogonal DFT matrix as the DFT matrix. In such embodiments, the extended Low-PAPR sequence rₛ(n,m) may be generated as below:

$${r}_{s} ( n , m ) = {e}^{\frac{j 2 π s ( 14 n + m )}{168}} \cdot {\overline{r}}_{u , v} ( n ) \qquad ( 5 )$$

On the other hand, if the number of the information bits is above 7, the terminal device 120 may determine a non-orthogonal DFT matrix as the DFT matrix. In such embodiments, if K=11, the extended Low-PAPR sequence rₛ(n,m) may be generated as below:

$${r}_{s} ( n , m ) = {e}^{\frac{j 2 π s ( 14 n + m )}{2048}} \cdot {\overline{r}}_{u , v} ( n ) \qquad ( 6 )$$

In some embodiments, the extended Low-PAPR sequence may be mapped to two different RBs with frequency hopping. In such embodiments, the terminal device 120 may split the information bits in the UCI into a first subset of the information bits and a second subset of the information bits. Then, the terminal device 120 may generate a first value for the first subset and a second value for the second subset. In turn, the terminal device 120 may generate a first part of the sequence and a second part of the sequence based on the first value and the second value, respectively.

Upon generating the first part and the second part of the sequence, terminal device 120 may transmit the first part of the sequence in a first RB and the second part of the sequence in a second RB. The second RB is different from the first RB.

In some embodiments, in order to improve the detection performance for the sequence, the terminal device 120 may split the information bits in the UCI such that the first subset comprises information bits in even positions of the information bits, and the second subset comprises information bits in odd positions of the information bits.

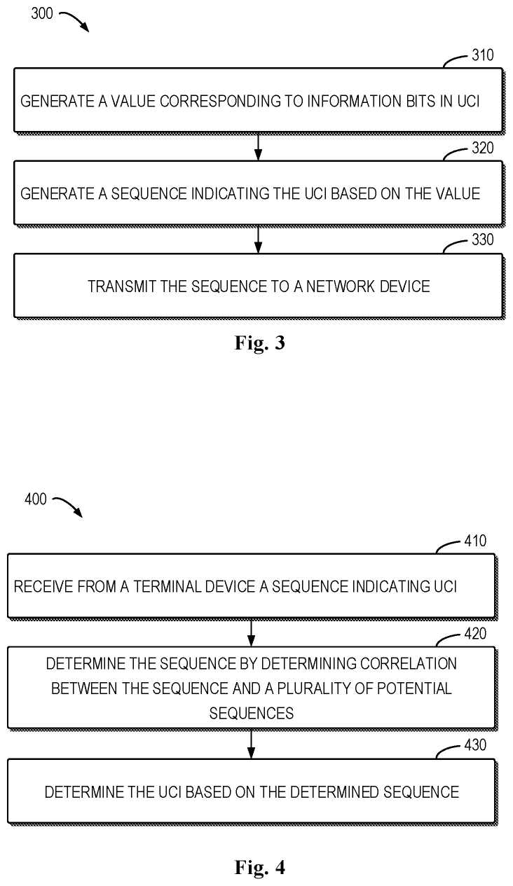

FIG. 3 illustrates a flowchart of an example method 300 in accordance with some embodiments of the present disclosure. In some embodiments, the method 300 can be implemented at a terminal device, such as the first terminal device 120 as shown in FIG. 1. Additionally or alternatively, the method 300 can also be implemented at the second terminal device 130 or other terminal devices not shown in FIG. 1. For the purpose of discussion, the method 300 will be described with reference to FIG. 1 as performed by the terminal device 120 without loss of generality.

At block 310, the terminal device 120 generates a value corresponding to UCI. At block 320, the terminal device 120 generates a sequence indicating the UCI based on the value. At block 330, the terminal device 120 transmits the sequence to a network device.

In some embodiments, generating the sequence comprises: in accordance with receiving a signaling indicating a type of the sequence, generating the sequence based on the signaling.

In some embodiments, the sequence comprises a pseudo-random sequence.

In some embodiments, the pseudo-random sequence comprises a Gold sequence having a length of 31.

In some embodiments, generating the sequence comprises: determining a parameter for initializing a generator for the pseudo-random sequence based on the value; and generating the sequence based on the parameter.

In some embodiments, determining the parameter comprises: updating the value based on 2^{d}s, where s represents the value and d represents a position of s; and determining the parameter based on the updated value.

In some embodiments, generating the value comprises: updating the information bits by appending at least one padding bit to the information bits based on the number of the information bits and the maximum information bits in sequence based transmission; and generating the value based on the updated information bits.

In some embodiments, the sequence comprises an extended Low-PAPR sequence.

In some embodiments, generating the sequence comprises: generating a first set of orthogonal sequences in frequency domain based on the value; generating a second set of orthogonal sequences in time domain based on the value; and generating the extended Low-PAPR sequence by multiplying the first and second sets of orthogonal sequences by a Low-PAPR base sequence.

In some embodiments, generating the sequence comprises: selecting a second predetermined number of elements from a Discrete Fourier Transformation, DFT, matrix based on the value; and generating the extended Low-PAPR sequence by multiplying the selected elements by a Low-PAPR base sequence.

In some embodiments, generating the sequence further comprises: in accordance with a determination that the number of the information bits is below a second threshold number, determining an orthogonal DFT matrix as the DFT matrix.

In some embodiments, generating the sequence further comprises: in accordance with a determination that the number of the information bits is above the second threshold number, determining a non-orthogonal DFT matrix as the DFT matrix.

In some embodiments, generating the value for the information bits comprises: splitting the information bits into a first subset of the information bits and a second subset of the information bits; and generating a first value for the first subset and a second value for the second subset. In such embodiments, generating the sequence comprises: generating a first part of the sequence and a second part of the sequence based on the first value and the second value, respectively. In such embodiments, transmitting the sequence comprises: transmitting the first part of the sequence in a first resource block and the second part of the sequence in a second resource block different from the first resource block.

In some embodiments, the first subset comprises information bits in even positions of the information bits, and the second subset comprises information bits in odd positions of the information bits.

In some embodiments, transmitting the sequence comprises: in accordance with reception of a signaling from the network device, transmitting the sequence, the signaling indicating that the sequence is to be transmitted. In some embodiments, the signaling indicates a format of a control channel on which the sequence is to be transmitted.

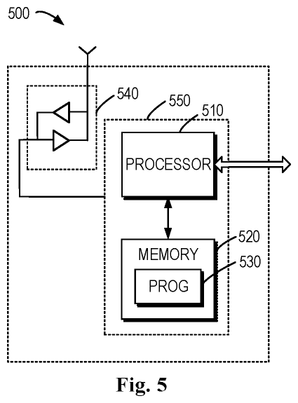

FIG. 4 illustrates a flowchart of an example method 400 in accordance with some embodiments of the present disclosure. In some embodiments, the method 400 can be implemented at a network device, such as the network device 110 as shown in FIG. 1. Additionally or alternatively, the method 400 can also be implemented at other network devices not shown in FIG. 1. For the purpose of discussion, the method 400 will be described with reference to FIG. 1 as performed by the network device 110 without loss of generality.

At block 410, the network device 110 receives from the terminal device 120 a sequence indicating UCI. At block 420, the network device 110 determines the sequence by determining correlation between the sequence and a plurality of candidate sequences. At block 430, the network device 110 determines the UCI based on the determined sequence.

In some embodiments, the method 400 further comprises: transmitting a signaling indicating a type of the sequence to the terminal device.

In some embodiments, the sequence comprises one of the following: a Gold sequence, or an extended Low-PAPR sequence.

In some embodiments, receiving the sequence comprises: receiving a first part of the sequence in a first resource block and a second part of the sequence in a second resource block different from the first resource block.

In some embodiments, receiving the sequence comprises: transmitting to the terminal device a signaling indicating that the sequence is to be transmitted; and receiving the sequence transmitted from the terminal device in response to the signaling. In some embodiments, the signaling may further indicate a format of a control channel on which the sequence is to be transmitted.

FIG. 5 is a simplified block diagram of a device 500 that is suitable for implementing some embodiments of the present disclosure. The device 500 can be considered as a further example embodiment of the network device 110, the first terminal device 120 and the second terminal device 130 as shown in FIG. 1. Accordingly, the device 500 can be implemented at or as at least a part of the network device 110, the first terminal device 120 and the second terminal device 130.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 530 is assumed to include program instructions that, when executed by the associated processor 510, enable the device 500 to operate in accordance with the embodiments of the present disclosure, as discussed herein with reference to FIGS. 2 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communications, comprising:
generating, at a terminal device, a value corresponding to information bits in uplink control information, UCI;
generating a sequence indicating the UCI based on the value; and
transmitting the sequence to a network device.

2. The method of claim 1, wherein generating the sequence comprises:
in accordance with receiving a signaling indicating a type of the sequence, generating the sequence based on the signaling.

3. The method of claim 1, wherein the sequence comprises a pseudo-random sequence.

4. The method of claim 3, wherein the pseudo-random sequence comprises a Gold sequence having a length of 31.

5. The method of claim 3, wherein generating the sequence comprises:
determining a parameter for initializing a generator for the pseudo-random sequence based on the value; and
generating the sequence based on the parameter.

6. The method of claim 5, wherein determining the parameter comprises:
updating the value based on the value multiplying 2 to the d^{th} power, d represents a position of the value in a length of the pseudo-random sequence; and
determining the parameter based on the updated value.

7. The method of claim 5, wherein determining the parameter comprises:
determining the parameter based on the following: the value, a position of the value in a length of the pseudo-random sequence, the number of OFDM symbols in one slot, an OFDM symbol index within the slot, an index of the slot within a radio frame, and an identity.

8. The method of claim 5, wherein determining the parameter further comprises:
determining the parameter based on the following:
cᵢₙᵢₜ=(2^{d}s+2¹⁷(N_{symb}^{slot}n_{s,f}^{μ}+l+1)(2N_{ID}⁰+1)+2N_{ID}⁰)mod 2³¹
where cᵢₙᵢₜ represents the parameter, s represents the value, d represents a position of the value in a length of the pseudo-random sequence, N_{symb}^{slot} represents the number of OFDM symbols in one slot, l represents an OFDM symbol index within the slot, n_{s,f}^{μ} represents an index of the slot within the radio frame, and N_{ID}⁰ represents an identity.

9. The method of claim 1, wherein generating the value comprises:
updating the information bits by appending at least one padding bit to the information bits based on the number of the information bits and the maximum information bits in sequence based transmission; and
generating the value based on the updated information bits.

10. The method of claim 1, wherein the sequence comprises an extended Low-PAPR sequence.

11. The method of claim 10, wherein generating the sequence comprises:
generating a first set of orthogonal sequences in frequency domain based on the value;
generating a second set of orthogonal sequences in time domain based on the value; and
generating the extended Low-PAPR sequence by multiplying the first and second sets of orthogonal sequences by a Low-PAPR base sequence.

12. The method of claim 10, wherein generating the sequence comprises:
selecting a second predetermined number of elements from a Discrete Fourier Transformation, DFT, matrix based on the value; and
generating the extended Low-PAPR sequence by multiplying the selected elements by a Low-PAPR base sequence.

13. The method of claim 12, wherein generating the sequence further comprises:
in accordance with a determination that the number of the information bits is below a second threshold number, determining an orthogonal DFT matrix as the DFT matrix.

14. The method of claim 13, wherein generating the sequence further comprises:
in accordance with a determination that the number of the information bits is above the second threshold number, determining a non-orthogonal DFT matrix as the DFT matrix.

15-17. (canceled)

18. A method for communications, comprising:
receiving, at a network device from a terminal device, a sequence indicating uplink control information, UCI;
determining the sequence by determining correlation between the sequence and a plurality of candidate sequences; and
determining the UCI based on the determined sequence.

19. The method of claim 18, further comprising:
transmitting a signaling indicating a type of the sequence to the terminal device.

20. The method of claim 18, wherein the sequence comprises one of the following:
a pseudo-random sequence, or
an extended Low-PAPR sequence.

21. The method of claim 20, wherein the pseudo-random sequence comprises a Gold sequence having a length of 31.

22. The method of claim 18, wherein receiving the sequence comprises:
receiving a first part of the sequence in a first resource block and a second part of the sequence in a second resource block different from the first resource block.

23. (canceled)

24. A terminal device, comprising:
a processor; and
a memory coupled to the processor and storing instructions thereon, the instructions, when executed by the processor, causing the terminal device to perform the method according to claim 1.

25-27. (canceled)
